(19) United States
(12) Patent Application Publication
(10) Pub. No.: US 2015/0368088 A1
(43) Pub. Date: Dec. 24, 2015

(54) SYSTEM AND METHOD FOR DISPENSING FUEL

(71) Applicant: SHELL OIL COMPANY, Houston, TX (US)

(72) Inventors: Dipesh Praful PATEL, Katy, TX (US); Earl Joseph BAUDIN, JR., Houston, TX (US); Brian Hale RICHARDS, Chicago, IL (US); Billy Gene EUELL, Jr., Sugar Land, TX (US)

(21) Appl. No.: 14/742,392

(22) Filed: Jun. 17, 2015

Related U.S. Application Data
(60) Provisional application No. 62/013,601, filed on Jun. 18, 2014.

(51) Int. Cl. B67D 7/04; G06Q 20/14; G06Q 30/02; G05B 15/02

(52) U.S. Cl. CPC B67D 7/04; G05B 15/02; G06Q 20/14; G06Q 30/0226

(57) ABSTRACT

A fuel dispensing system may include a fuel dispenser, a controller, an electronic payment server, a nozzle, and an interface. The fuel dispenser include a housing, and a fuel dispensing apparatus at least partially mounted in the housing. The controller may be operatively coupled to the fuel dispensing apparatus. The electronic payment server may be operatively coupled to the controller. The nozzle may be operatively coupled to the fuel dispensing apparatus and the controller. The interface may be operatively coupled to the electronic payment server and configured to receive information from an integration server that is configured to communicate with a loyalty server. The controller may be configured to selectively permit the dispensing of fuel through the nozzle in response to information received from the integration server.

### CROSS-REFERENCE TO RELATED APPLICATIONS

This application claims the benefit of U.S. Provisional Application No. 62/013,601, filed Jun. 18, 2014, the entirety of which is incorporated herein by reference.

### FIELD OF THE INVENTION

The invention relates to a system and method for dispensing fuel.

### BACKGROUND

In recent years, fuel dispensers have become more than a means for fueling a vehicle. Service stations provide an increasing number of services at the fuel dispenser, including advertising, rebates, discounts, loyalty program benefits, and the like. Additionally, some fuel dispensers facilitate ordering other onsite services, such as car washes. Many fuel dispensers include card readers allowing payment for fuel and/or other services or products. As the amount of information and variety of products and services provided to the consumer increases, the number of ways to present relevant information to the customer also increases.

A typical fuel dispensing system includes multiple fuel dispensers each having two fueling positions, and a central site controller. Sophisticated dispenser systems incorporate expensive, hardware-intensive controllers in each fuel dispenser. Some fuel dispensers include a display (or screen) and/or touch pad to order goods or services or to provide messaging. Generally, changing the various options or presentations involves changing firmware or downloading new software to each dispenser. With any software application, revisions are necessary, requiring upgrade to every dispenser at every desired location. Thus, even small changes can be time consuming and expensive.

As fuel dispensers get more interactive, the trend is to increase the computational ability within each dispenser to provide additional functionality. The cost to upgrade each fuel dispenser with the computational horsepower to fully realize multimedia applications or other customization is often prohibitive, and providing customized software for each upgraded fuel dispenser involves significant cost and labor. Further, it may take months to upgrade the fuel dispensers to incorporate a desired change. Because of the length of time for development to move from concept to full integration, users frequently desire a new upgrade to the fuel dispensers before the preceding upgrade is fully integrated.

### SUMMARY OF THE INVENTION

A fuel dispensing system may include a fuel dispenser, a controller, an electronic payment server, a nozzle, and an interface. The fuel dispenser include a housing, and a fuel dispensing apparatus at least partially mounted in the housing. The controller may be operatively coupled to the fuel dispensing apparatus. The electronic payment server may be operatively coupled to the controller. The nozzle may be operatively coupled to the fuel dispensing apparatus and the controller. The interface may be operatively coupled to the electronic payment server and configured to receive information from an integration server that is configured to communicate with a loyalty server. The controller may be configured to selectively permit the dispensing of fuel through the nozzle in response to information received from the integration server.

A method may include receiving, at an integration server that is configured to communicate with an electronic payment server and with a loyalty server, a message including a customer identifier and a fuel dispenser identifier. The method may also include transmitting, from the integration server to the loyalty server, a loyalty request message including the customer identifier. The method may include receiving, at the integration server from the loyalty server, a loyalty completion message. The method may further include transmitting, from the integration server, an instruction to dispense fuel at a fuel dispenser corresponding to the fuel dispenser identifier.

### BRIEF DESCRIPTION OF THE FIGURES

FIG. 1 is a schematic of a fuel dispensing system incorporating an integration server remote from a fuel dispenser.

FIG. 2 is a schematic of another embodiment of a fuel dispensing system incorporating an integration server remote from a fuel dispenser.

FIG. 3 is a schematic of yet another embodiment of a fuel dispensing system incorporating an integration server remote from a fuel dispenser.

FIG. 4 is a schematic of one embodiment of architecture of a system utilizing an integration server remote from a fuel dispenser.

FIG. 5 is a schematic of another embodiment of architecture of a system utilizing an integration server remote from a fuel dispenser.

FIG. 6 is a schematic of yet another embodiment of architecture of a system utilizing an integration server remote from a fuel dispenser.

FIG. 7 is a schematic of an embodiment of architecture of a system utilizing an integration server remote from a fuel dispenser.

FIG. 8 is a schematic of one embodiment of architecture of a system utilizing an integration server remote from a fuel dispenser.

FIG. 9 is a schematic of another embodiment of architecture of a system utilizing an integration server remote from a fuel dispenser.

### DETAILED DESCRIPTION

Conventional fuel dispensing systems have increasingly complex software onsite. Thus, adding additional functionality involves changes at the site. An improved fuel dispensing system includes an integration server remote from the fuel dispensers. That remote integration server can interact with fuel dispensers at multiple sites, allowing software upgrades to occur at a centralized location, providing improved timing, reduced labor, and reduced cost for updates. An upgrade to an onsite server might influence several fuel dispensers at that site. However, such an upgrade still requires a time intensive technician visit to the site to upgrade the server. If many sites require upgrading, multiple technicians may spend quite a long time visiting each of the sites and providing the upgrade. In the improved system, however, an upgrade to the remote integration server may instantaneously have an impact on fuel dispensers at any number of sites in communication with the server. Thus, the improvements described below can reduce the time, labor, and expense associated with upgrading and maintaining multiple onsite servers. Additional advantages will be apparent from the description below.

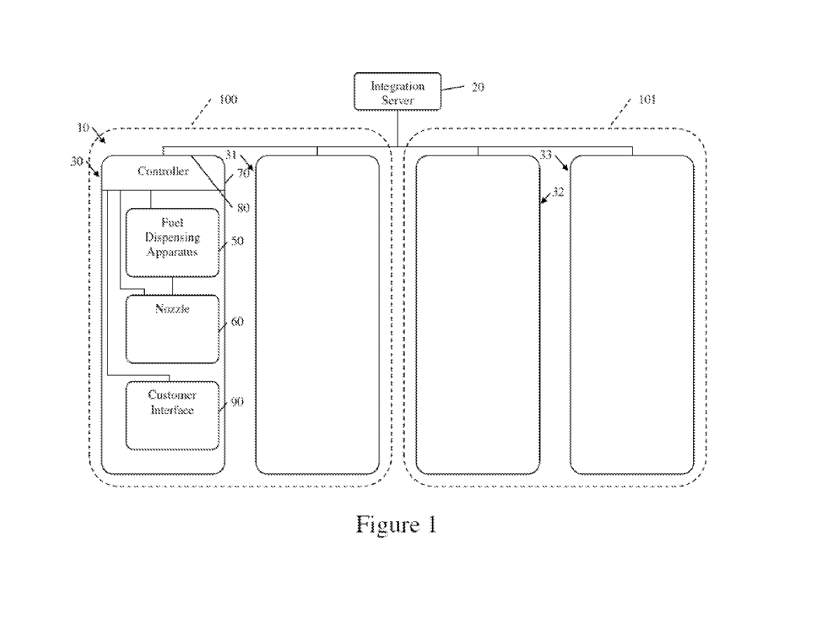

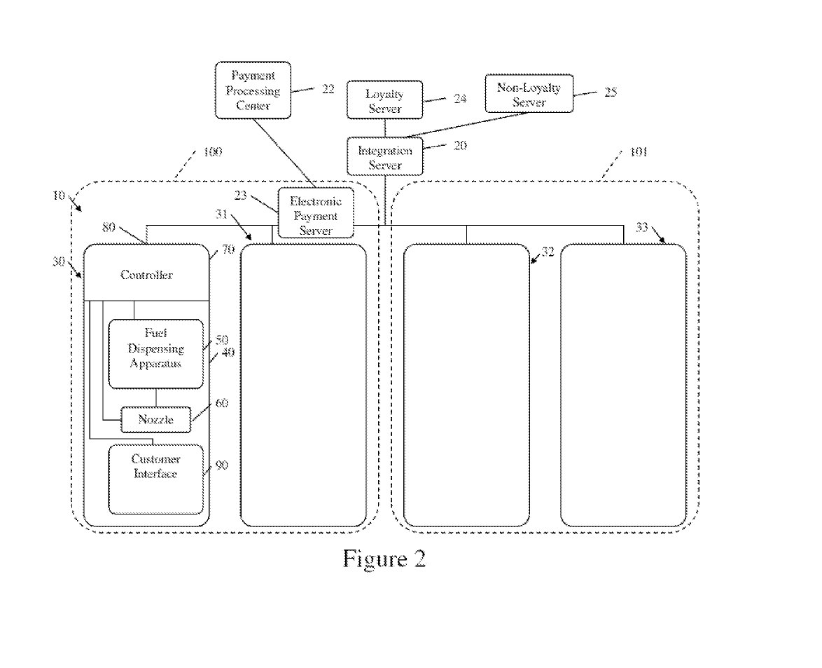

Referring to FIGS. 1 and 2, a system for dispensing fuel (e.g., gasoline or diesel products) may include an off-site integration server 20 and an on-site fuel dispensing system 10. The integration server 20 may be configured to communicate directly or indirectly with multiple fuel dispensers (e.g., 30, 31) in the fuel dispensing system 10 such that the integration server 20 can communicate with at least two of a plurality of fuel dispensers (e.g., 30, 31, 32, etc.) that are remote from one another (i.e., not at the same site). While multiple fuel dispensers may be at any given site (e.g., fuel dispensers 30 and 31 at site 100), the integration server 20 is preferably configured to communicate with at least one fuel dispenser at each of at least two different sites (e.g., sites 100 and 101), preferably multiple fuel dispensers at multiple different sites (e.g., fuel dispensers 30 and 31 at site 100 and fuel dispensers 32 and 33 at site 101). The integration server 20 may be remote from any or all of the plurality of fuel dispensers. The communications between the integration server 20 and the plurality of fuel dispensers may be in a single direction or in multiple directions. Thus, the integration server 20 may be configured to transmit information directly or indirectly to the plurality of fuel dispensers, to receive information from the plurality of fuel dispensers, or both. Further, information received from the plurality of fuel dispensers may be either directly transmitted or indirectly transmitted (e.g., via electronic payment server 23 and/or a customer's cellular network) to the integration server 20 as described further below.

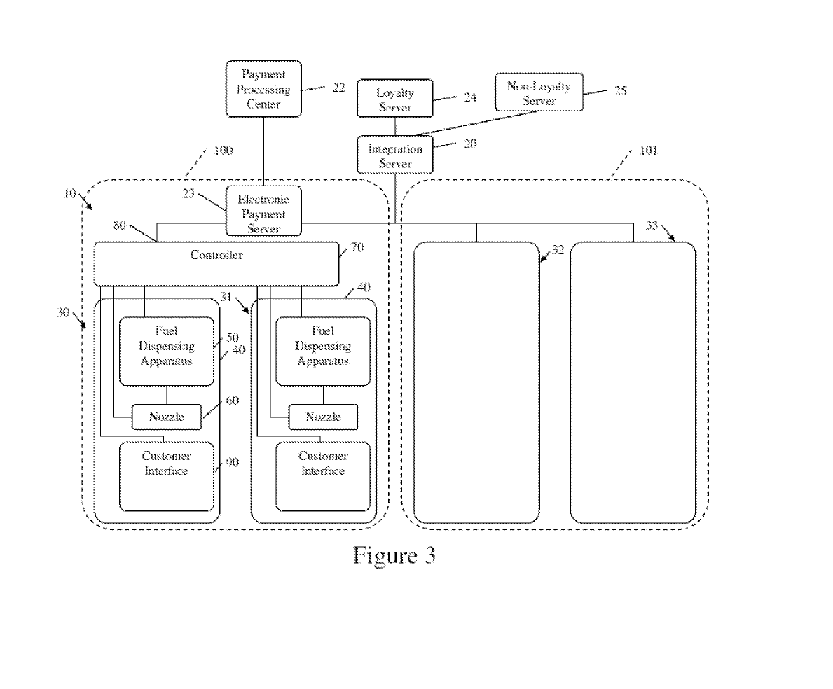

Each of the plurality of fuel dispensers may have different features or each may have features similar to the features of the fuel dispenser 30 as described below. The fuel dispenser 30 may have a housing 40, a fuel dispensing apparatus 50 at least partially mounted in the housing 40, and a nozzle 60 that is also associated with the housing 40. The fuel dispensing apparatus 50 may include an underground storage tank, a pump, piping, a valve, a gauge or meter, and a hose connected to the nozzle 60. While portions of the fuel dispensing apparatus 50 may lie outside the housing 40, other portions may lie partially or wholly within or on the housing 40 (i.e., at least partially mounted in the housing 40). The fuel dispensing system 10 may also include a controller 70 operatively coupled to the fuel dispensing apparatus 50. The nozzle 60 may operatively couple to the fuel dispensing apparatus 50 and to the controller 70. The fuel dispensing system 10 may include an interface 80 (e.g., wired connection or wireless fidelity (Wi-Fi) connection) operatively coupled to the controller 70 and configured to receive information from the integration server 20. The configuration of the fuel dispensing system 10 may be such that, responsive to information received from the integration server 20 at the interface 80, the controller 70 selectively permits the dispensing of fuel through the nozzle 60. Thus, the integration server 20 may provide instruction to the controller 70 via the interface 80 to release the nozzle 60 for fueling. The controller 70 may be remote from the fuel dispenser 30 while remaining operatively coupled to the fuel dispenser 30. Thus, one controller may operatively couple to a plurality of fuel dispensers at multiple sites (not shown). Similarly, one controller may be operatively coupled to a plurality of fuel dispensers at a particular site (e.g., as shown in FIG. 3). The interface 80 associated with the controller 70 may be mounted in or otherwise attached to the housing 40 of the fuel dispenser 30 or may be outside the housing 40 (e.g., when one controller is used for multiple fuel dispensers). Further, in some embodiments, the controller 70 may be included in or eliminated by the corresponding functionality of the offsite integration server 20 such that the interface 80 between the two is unnecessary.

Referring now to FIG. 2, the fuel dispensing system 10 may include an electronic payment server 23 operatively coupled to the controller 70 (e.g., along the interface 80 between the controller 70 and the integration server 20). The electronic payment server 23 may also be operatively coupled to a payment processing center 22, which may be controlled by a third party or which may be included as part of the system for dispensing fuel 10. The electronic payment server 23 may mount in the housing 40 and may couple to a point of sale in a traditional manner, or the electronic payment server 23 may be separate from the point of sale, allowing for increased flexibility. Thus, the electronic payment server 23 may be remote from the fuel dispenser 30, allowing one electronic payment server 23 to communicate with fuel dispensers at multiple sites, or for multiple fuel dispensers at a particular site. The electronic payment server 23 may be configured to receive information from the integration server 20 via a wired interface, as illustrated, or otherwise (e.g., Wi-Fi). The integration server 20 may be configured to communicate with a loyalty server 24 and/or with a non-loyalty server 25.

The loyalty server 24 and the non-loyalty server 25 may each be included within the fuel dispensing system 10. Alternatively, the loyalty server 24 and/or the non-loyalty server 25 may be outside of the fuel dispensing system 10 or the loyalty server 24 and/or the non-loyalty server 25 may include multiple servers or databases, some of which are within the fuel dispensing system 10 and others of which are outside the fuel dispensing system 10. Likewise, the loyalty server 24 and/or the non-loyalty server 25 may be partially or completely under the control of different third parties. As used herein, the terms “loyalty server” and “non-loyalty server” each refer to a server, database, or other source from which information may be retrieved by the integration server 20. Generally, the loyalty server 24 may provide information relating to one or more loyalty programs, and the non-loyalty server 25 may provide information relating to something other than the loyalty program or programs associated with the loyalty server 24. Thus, the integration server 20 may query the loyalty server 24 for loyalty related information and may query the non-loyalty server 25 for any other information. In some applications, the integration server 20 may not communicate with the non-loyalty server 25 at all. Rather, the integration server 20 may incorporate the functionality of the non-loyalty server 25, such that the integration server 20 performs the tasks otherwise associated with the non-loyalty server 25. Further, other server or servers having different delineation unrelated to loyalty may replace each the loyalty server 24 and the non-loyalty server 25. For example, the inclusion of private customer information may be the delineating characteristic and the servers may thus be a customer information server relating to customer specific features and a promotions server relating to promotions unrelated to the particular customer. Similarly, the delineating characteristic may relate to the type of customer information with the electronic payment server 23 handling financial information and a non-electronic payment server (e.g., loyalty server 24) handling all other information. Alternatively, the delineating characteristic may be whether the company or a third party controls the servers with the corresponding servers including a third party server and a company-controlled server. Thus, the methods set forth below may apply to these or other servers, which may have these or other delineating characteristics.

The fuel dispensing system 10 may also include at least one customer interface 90 (e.g., display screen with accompanying input) mounted in the housing 40 and operatively coupled to the controller 70 such that, responsive to the receipt of information from the integration server 20, the customer interface 90 may display a message. The customer interface 90 may display other messages, including those not passing through the integration server 20. For example, a message indicating approval of payment may originate from the payment processing center 22 and pass through the electronic payment server 23 to the controller 70 and finally to the customer interface 90. The customer interface 90 may mount in the housing 40 or multiple housings may share the customer interface 90. For example, a kiosk is one example of a customer interface that may serve multiple fuel dispensers. The kiosk may have a keypad and card reader, while the housings may each have an individual display screen. Alternatively, multiple housings may share both the input and output functionality of the customer interface 90 at a single kiosk or other device (e.g., mobile touch screen device). The message may be any kind of communication to the customer. The message may include an indication of approval of the transaction, discounted fuel price, a social media message, a special offer, etc. Likewise, the message may not be specific to the customer, but may be a mass message, a regional message, wholesaler message, a service station message, or even a message specific to the fuel dispenser 30. Variable messaging may be delivered at pre fueling, fueling, and/or post fueling stages in the transaction, and, in addition to varying according to fueling stage, the messaging may be varied depending upon the capabilities of the fuel dispensing system 10 (e.g., screen size, resolution, color capabilities, etc.).

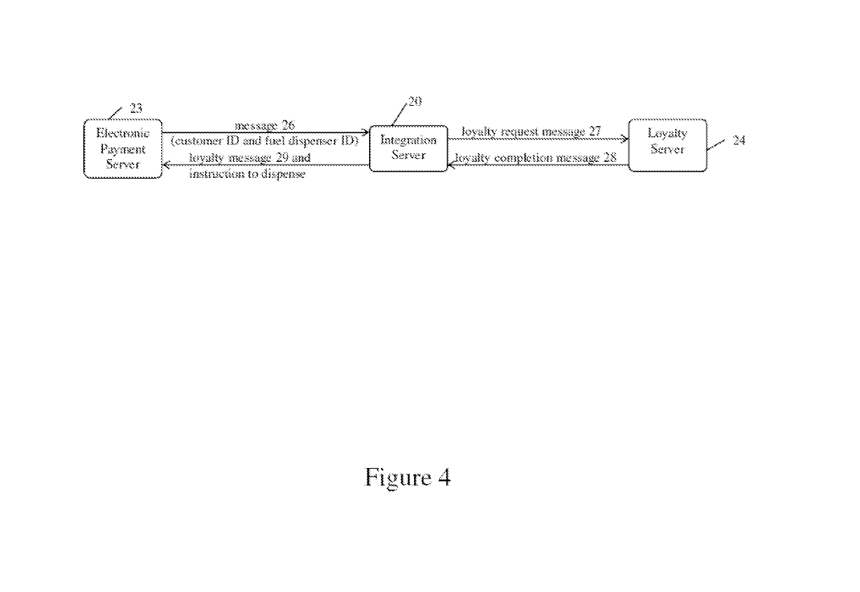

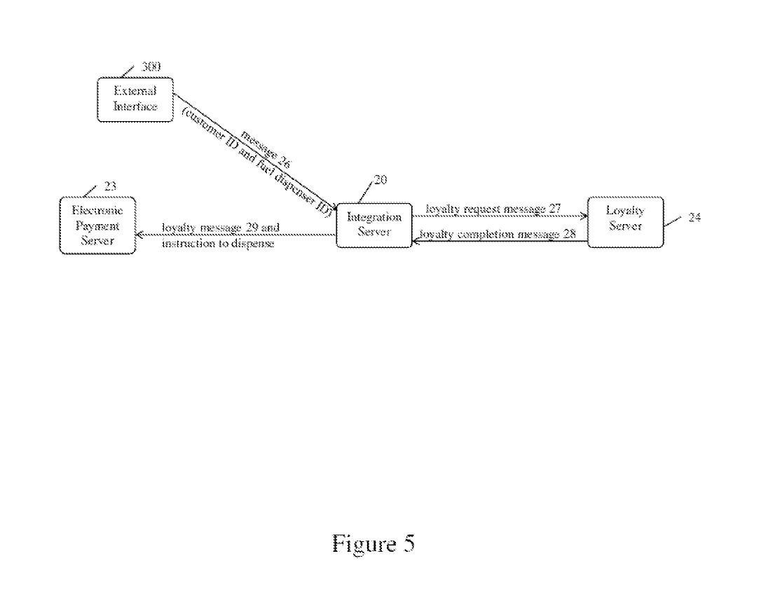

Referring now to FIG. 4, a method of dispensing fuel may begin when the integration server 20 receives a message 26 including a customer identifier and a fuel identifier corresponding to the particular customer and fuel dispenser. The message 26 may be transmitted from the electronic payment server 23 to the integration server 20 as illustrated in FIG. 4, from an external interface 300 (e.g., the cellular network of a customer) as illustrated in FIG. 5, or otherwise. Thus, the integration server 20 may be configured to receive the message 26 from a fuel dispenser 30 via the electronic payment server 23 in response to the customer providing an indication (e.g., via credit card swipe) of the customer identifier at the fuel dispenser. Alternatively, the integration server 20 may be configured to receive the message 26 from an external interface 300 such as the customer's cellular network, in response to the customer interacting with a fuel dispenser operatively coupled to the electronic payment server 23 (e.g., obtaining and sending the fuel dispenser identifier from the fuel dispenser, through the customer's cellular network, to the integration server 20).

Once the integration server 20 has received the message 26 with the customer and fuel dispenser identifiers, the integration server 20 may transmit a loyalty request message 27 to the loyalty server 24. The loyalty request message 27 may include the customer identifier, the fuel dispenser identifier, and/or other information necessary for the loyalty server 24 to provide a desired response. The loyalty server 24 may then transmit, and the integration server 20 may receive, a loyalty completion message 28. The loyalty completion message 28 may provide an indication of loyalty status, extent, etc. Based on the loyalty completion message 28, the integration server 20 may transmit a loyalty message 29 to the electronic payment server 23. Additionally, an instruction to dispense fuel may be transmitted from the integration server to the fuel dispenser associated with the fuel dispenser identifier (e.g., via electronic payment server 23). The loyalty message 29, the instruction to dispense, or some other portion of the message from the integration server 20 to the electronic payment server 23 may cause the display of a message tailored to the customer associated with the customer identifier used in the message 26.

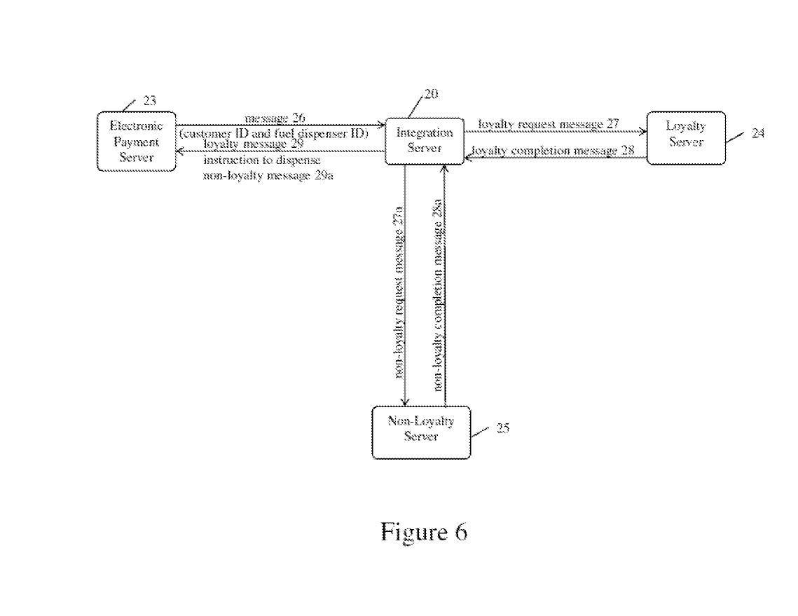

Referring now to FIG. 6, the integration server 20 shown therein may interact with the electronic payment server 23 and the loyalty server 24 as described above. Further, the non-loyalty server 25 may interact with the integration server 20. Thus, the integration server 20 may transmit and the non-loyalty server 25 may receive a non-loyalty request message 27a. The non-loyalty request message 27a may include the customer identifier, the fuel dispenser identifier, and/or other information necessary for the non-loyalty server 25 to provide a desired response. The non-loyalty server 25 may then transmit, and the integration server 20 may receive, a non-loyalty completion message 28a. The non-loyalty completion message 28a may provide an indication of non-loyalty status, such as social media, video, upselling messages, or any other information targeted to the customer or another party. Based on the non-loyalty completion message 28a, the integration server 20 may transmit a non-loyalty message 29a to the electronic payment server 23.

The loyalty request message 27 may include information necessary for the loyalty server 24 to determine whether the customer identifier is associated with a record in a database accessible to the loyalty server 24. Likewise, the non-loyalty request message 27a may include information necessary for the non-loyalty server 25 to determine whether the customer identifier is associated with a record in a database accessible to the non-loyalty server 25. The loyalty completion message 28 may include information regarding a determination by the loyalty server 24 whether the customer identifier is associated with a record in a database accessible to the loyalty server 24. Likewise, the non-loyalty completion message 28a may include information regarding a determination by the non-loyalty server 25 whether the customer identifier is associated with a record in a database accessible to the non-loyalty server 25.

A method of dispensing fuel may use the system described above, or another similar system. The method may include receiving, at the integration server 20 configured to communicate directly with a plurality of fuel dispensers that are remote from one another, a message including a customer identifier and a fuel dispenser identifier for a particular one of the fuel dispensers (e.g., fuel dispenser 30). Alternatively, the method may include receiving, at the integration server 20 configured to communicate indirectly with a plurality of fuel dispensers (e.g., via electronic payment servers 23) that are remote from one another, a message including a customer identifier and a fuel dispenser identifier for a particular one of the fuel dispensers (e.g., fuel dispenser 30). The method may also include determining, based on the customer identifier, payment approval or disapproval, and responsive to a determination of payment approval, transmitting a message from the integration server 20 to the particular fuel dispenser instructing the particular fuel dispenser to dispense fuel. The particular fuel dispenser may transmit the message received at the integration server 20 in response to the customer providing an indication of the customer identifier. Alternatively, an external interface 300, such as the customer's cellular network, a wireless internet connection, or other interface, may transmit the message received at the integration server 20 in response to the customer obtaining a fuel dispenser identifier or otherwise interacting with the particular fuel dispenser. Determining payment approval or disapproval may include receiving, at the integration server 20, an indication from a payment-processing center 22 of payment approval or disapproval. Receiving the indication of payment approval or disapproval may occur in response to transmitting an inquiry to the payment-processing center 22 from the integration server 20 as to payment approval or disapproval.

The method may include determining whether the customer identifier is associated with a record in a database 21, and responsive to a determination that the customer identifier is associated with a record in the database 21, transmitting a signal from the integration server 20 to the particular fuel dispenser to display a message tailored to the customer associated with the customer identifier. The method may include determining whether the customer identifier is associated with a record in the database 21, and responsive to a determination that the customer identifier is associated with a record in the database 21, transmitting a message to the database 21 to update a customer record. Thus, for example, a record in the database 21 may contain current information on various parameters, such as the amount of fuel purchased by the customer in the preceding month, the locations of fueling for the customer in the last year, preferences as to fuel type, information regarding responsiveness to various marketing campaigns, or other information. Various reward programs may use the parameters, providing desired updated information. Thus, the updated customer record may relate to customer tracking information. Likewise, the updated customer record may relate to a stored reward value for a customer associated with the customer identifier. For example, the customer may utilize a discount and the database 21 may update to reflect that the discount is no longer available. Alternatively, the customer may reach a threshold for a reward and the database 21 may update to reflect such information in a subsequent transaction. Any number of databases may be used for any of a number of different purposes. Preferably, at least one of the databases relates to one or more loyalty programs and non-loyalty programs.

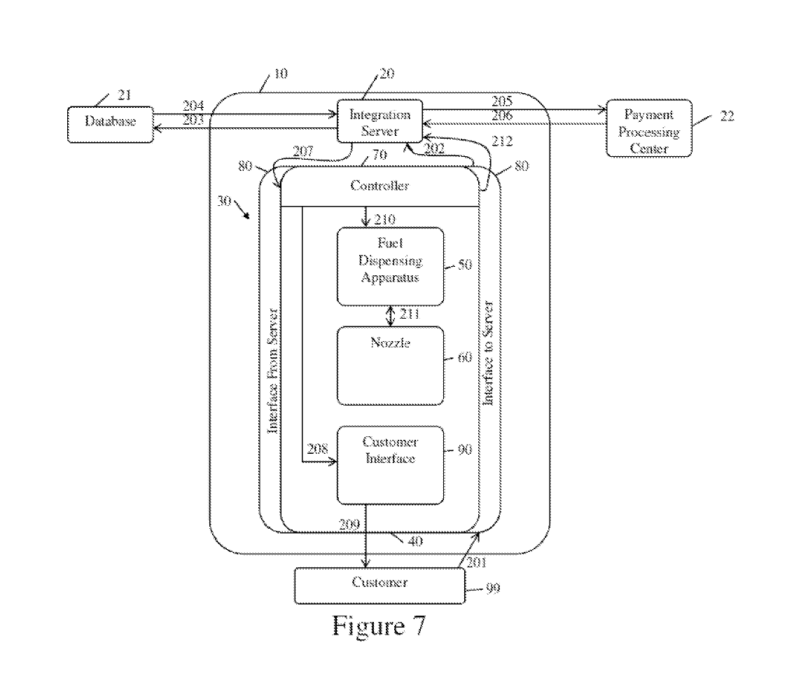

Referring to FIG. 7, a customer 99 desirous of obtaining fuel may approach the fuel dispensing system 10 (e.g., at fuel dispenser 30). At step 201, the customer 99 may provide the fuel dispensing system 10 with a customer identifier. The customer identifier may be any data set associated with the customer 99, including a numeric string, name, IP address, or any other identifying and unique code or reference. Examples of customer identifiers include, but are not limited to loyalty card account number, alternative identification number, phone number, registered payment card account number, etc. The customer 99 may provide the customer identifier via the customer interface 90 or other apparatus for transmitting information to the integration server 20. Such customer interface may include a display screen to provide information to the customer and an input for receiving information from the customer. The input may include a pad, barcode scanner, magnetic stripe reader, fingerprint scanner, tap and pay antenna or any other interface mounted in the housing 40, available nearby, or otherwise available to the customer 99. The customer interface 90 may further include an interface configured to transmit information from the fuel dispenser 30 to the integration server 20. The customer interface 90 may include external components. For example, the customer interface 90 may include the use of the customer's cellular network, utilizing the messaging and display capabilities of the customer's mobile device. At step 202, the fuel dispensing system 10 may then transmit (e.g., via wired connection or Wi-Fi) the information (e.g., customer identifier, along with a fuel dispenser identifier) to the integration server 20. The fuel dispenser identifier may be any data set associated with the fuel dispenser 30, which is unique to the fuel dispenser 30 and which assists to verify that the customer 99 has selected the fuel dispenser 30. Some exemplary fuel dispenser identifiers include a serial number, a Quick Response (QR) Code, a Universal Product Code (UPC), and Global Positioning System (GPS) Coordinates. While some of the fuel dispenser identifiers may be inaccessible to the customer (e.g., a serial number transmitted from the fuel dispenser 30 to the integration server directly or via the electronic payment server 23), other fuel dispenser identifiers may be accessible to the customer, allowing the customer to send information about the fuel dispenser identifier through the customer's cellular network to the integration server 20. For example, even if the customer is unaware of the identifying information, he may send GPS coordinates of his location to the integration server 20 though his cellular network and the integration server 20 may then associate those GPS coordinates with a particular fuel dispenser 30. The integration server 20 may reference at least one database 21 at step 203 to determine whether the database 21 contains information about the customer 99. If the database 21 contains information relating to the customer identifier, the database 21 may provide additional information about the customer 99 to the integration server 20 at step 204. Next, the integration server 20 may transmit the customer identifier and/or the additional information about the customer 99 to a payment-processing center 22 at step 205. The payment-processing center 22 may use the information received to determine approval or disapproval of the purchase of fuel by the customer 99. The payment-processing center 22 may then transmit an indication of the approval or denial to the integration server 20 at step 206. While a particular ordering of steps is set forth in this example, other ordering might be appropriate in certain situations.

Either or both of the database 21 and the payment processing center 22 may be operated or controlled by a party other than the party operating or controlling the integration server 20. Such a third party may include a grocer partner, a social media provider, a loyalty program manager, or any other strategic partner. The integration server 20 may also communicate directly or indirectly with the customer's cellular network, wholesalers, or other third parties, in addition to or instead of the database and/or the payment-processing center 22 described. For example, the database 21 may be replaced by a loyalty server 24 operated by a third party or by the same party operating the integration server 20. Likewise, while the figures illustrate a single database 21, the integration server 20 could reference multiple databases, either simultaneously, or in turn. Thus, real-time integration may occur between multiple loyalty awards services, including more than one points-based loyalty awards services, or between a loyalty awards service and a non-loyalty awards service (e.g., social media provider, retailer, etc.). Further, communications between the integration server 20 and the payment-processing center 22 may be direct communications as described, or indirect communications that may accomplish the same result.

Depending on the messaging systems of the integration server 20, the database 21, and the payment-processing center 22, the transmissions between them may each include an indication of customer identifier and/or additional information about the customer 99. Further, steps 205 and 206 may precede steps 203 and/or 204, depending on availability of the database 21 and the payment-processing center 22.

Once the integration server 20 has received additional information about the customer 99 and/or approval or denial of the purchase of fuel by the customer 99, the integration server 20 may transmit customized information to the fuel dispensing system 10 at step 207. At step 208, the controller 70 may instruct the customer interface 90 to communicate a message to the customer. At step 209, the fuel dispensing system 10 may then show a message on the customer interface 90 or otherwise communicate with the customer 99 based on the customized information. The customized information sent to the fuel dispensing system 10 at step 207 may include an instruction to the fuel dispenser 30 to dispense fuel. Thus, at step 210, the controller 70 may instruct the fuel dispensing apparatus 50 to release or allow fuel to flow through nozzle 60. The controller 70 may communicate with the fuel dispensing apparatus 50, providing an indication of volume of fuel dispensed or other data that might indicate a desirability to cease fueling. For example, flow may stop when the customer's tank is full, when the customer stops flow, when a predetermined limit of fuel has dispensed, or when the fuel dispensed reaches a preset price limit The fuel dispensing apparatus 50 may block flow through nozzle 60 in response to such feedback. The communications between the fuel dispensing apparatus 50 and the nozzle 60 are illustrated at step 211. While illustrated as being exclusively between the nozzle 60 and the fuel dispensing apparatus 50, this step 211 may also involve communications with the controller 70 and/or the integration server 20. Once fueling is complete, at step 212, the dispenser 30 may provide feedback to the integration server 20 (e.g., via the controller 70 through the interface 80 or otherwise) regarding any of a number of factors. For example, the fuel dispensing system 10 may provide an indication of the volume of fuel pumped, the type of fuel pumped, the time of pumping, whether the customer printed a receipt, or other information regarding the transaction, whether occurring before or after the integration server 20 last communicated with the fuel dispensing system 10. The integration server 20 may then communicate (not illustrated) with the database 21 and/or the payment processing center 22 to reflect the information received.

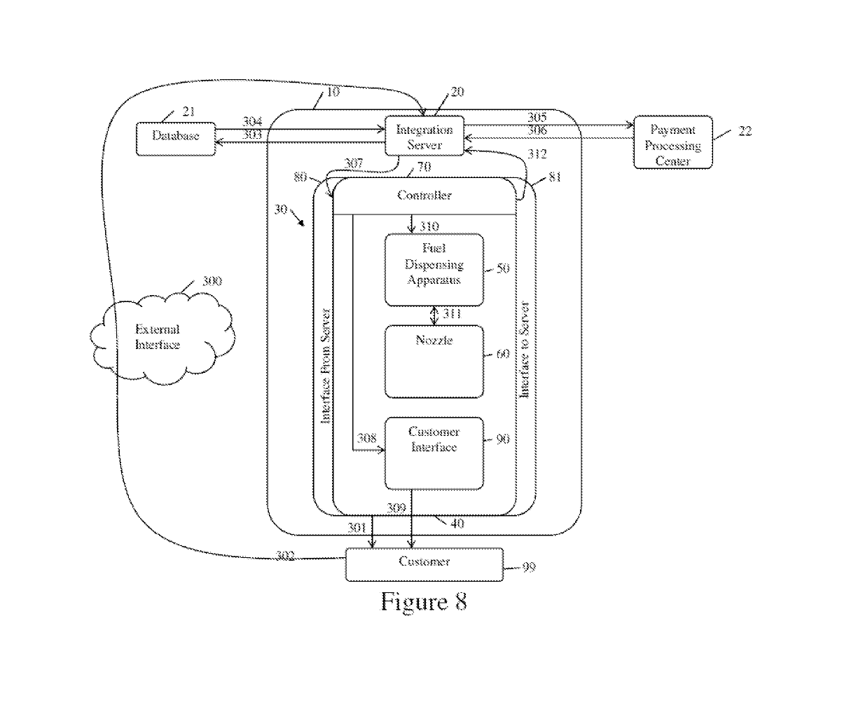

Referring now to FIG. 8, communications between the integration server 20 and the fuel dispensing system 10 may be in a single direction, such that the integration server 20 transmits information directly to the fuel dispensing system 10, but the fuel dispensing system 10 does not transmit information directly to the integration server 20. In the example illustrated, the customer 99 approaches the fuel dispensing system 10 (e.g., at fuel dispenser 30) as with the example of FIG. 7. However, instead of providing the customer identifier for direct transmission through an interface for transmitting information from the fuel dispensing system 10 to the integration server 20, the customer 99 obtains, from the fuel dispenser 30, the fuel dispenser identifier at step 301. Obtaining the fuel dispenser identifier may involve scanning a code (e.g., Quick Response (QR) Code, a Universal Product Code (UPC)), capturing Global Positioning System (GPS) coordinates, mobile check in by the customer 99 to the service station or location, the use of other location based services at the service station or location, or otherwise entering a unique identifier via a handheld wireless device or otherwise. At step 302, the customer 99 sends the fuel dispenser identifier, along with the customer identifier (e.g., a cellular phone number or other identification of the customer 99 automatically or otherwise provided when the customer 99 transmits the fuel dispenser identifier), through a cellular network, a nearby wireless internet connection, or other interface for indirectly transmitting information from the fuel dispensing system 10 to the integration server 20. Thus, the fuel dispensing system 10 may indirectly transmit the fuel dispenser identifier to the integration server 20. Additionally, the communication of customer identifier may bypass the fuel dispensing system 10, e.g., when the customer transmits the customer identifier to the integration server 20 via cellular network or other external interface 300. Steps 303 through 312 are substantially the same as steps 203 through 212 as described with respect to FIG. 7. Likewise, as with the embodiment of FIG. 7, additional communications between the integration server 20 and the various other elements may occur.

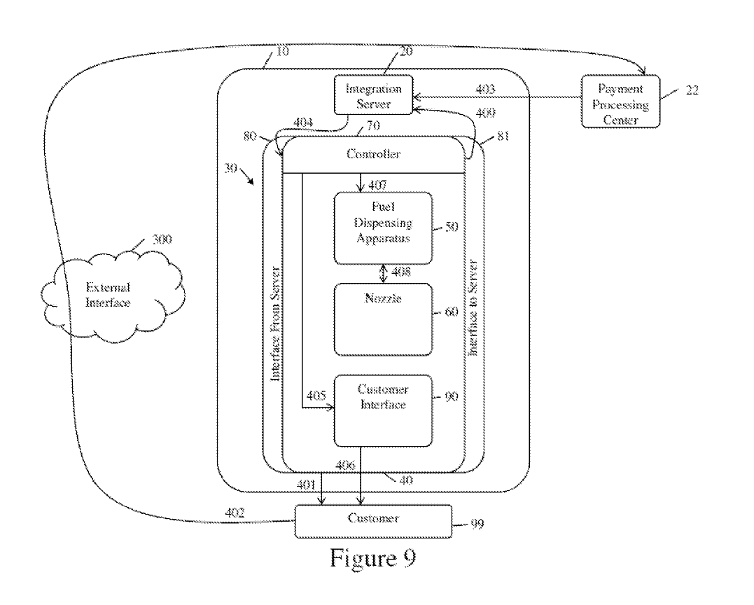

Referring now to FIG. 9, various elements of the system may be modified to provide the customer 99 with a fully tailored experience. As with FIG. 8, communications between the integration server 20 and the fuel dispensing system 10 may be in a single direction. However, the customer 99 may purchase fuel without the integration server 20 ever having access to a customer identifier. As with FIG. 8, the customer 99 may obtain, from the fuel dispensing system 10 (e.g., at fuel dispenser 30), the fuel dispenser identifier at step 401. At step 402, the customer 99 sends the fuel dispenser identifier, along with the customer identifier, through an external interface 300, such as a cellular network or other channel bypassing the fuel dispensing system 10. However, unlike the example of FIG. 8, the customer 99 may not send the identifier to the integration server 20, but may instead send the identifier to the payment-processing center 22 or to some other third party (not shown). The payment-processing center 22 or other third party may use the customer identifier to provide selected information to the integration server 20. For example, the payment-processing center 22 may determine approval or denial of the purchase of fuel by the customer 99. The payment-processing center 22 may then transmit an indication of the approval or denial to the integration server 20, along with an indication of the fuel dispenser identifier at step 403. The payment-processing center 22 may also transmit a transaction number or other identifier that conceals the identity of the customer 99 while allowing the transaction to proceed. Once the integration server 20 has received approval or denial of the purchase of fuel at the identified fuel dispenser 30, the integration server 20 may transmit customized information to the fuel dispensing system 10 at step 404. With the exception of anything involving customer identification, steps 404 through 409 are substantially the same as steps 203 through 212 as described with respect to FIG. 7. Likewise, as with the embodiment of FIG. 7, additional communications between the integration server 20 and the various other elements may occur.

The examples of FIGS. 7-9 illustrate that the integration server 20 may be configured to receive information from the fuel dispensing system 10, use the received information from the fuel dispensing system 10 to determine whether a condition has been met, and, responsive to the determination, to transmit information to the fuel dispensing system 10. For example, as illustrated in FIG. 7, the integration server 20 may receive information from the fuel dispensing system 10, in the form of a customer identifier and fuel dispenser identifier. The integration server 20 may determine whether a condition has been met using the information from the fuel dispensing system 10. Examples of conditions determined in the example of FIG. 7 include approval or denial of the transaction, and an indication of whether the customer identifier is associated with information in the database 21. Other examples of conditions which may be met include whether a discount is due, whether a particular fuel grade should be automatically selected, whether a reward is warranted, whether an offer should be presented, whether a particular message should be displayed, whether a receipt should be printed, whether fraud codes should be prompted, or any of a number of other parameters which may result from the association of information with the customer identifier in the database 21. Responsive to that determination, in the example of FIG. 7, the integration server 20 transmits customized information to the fuel dispensing system 10. Customized information may include an indication of payment authorization, pricing information, discount information, preselection of fuel type, information about special offers, information about coupons, information about weather or social media, other personalized information unique to the customer 99, or any other messaging information.

Providing customized information may involve the application various algorithms to ensure that the information is accurate and to ensure conveyance of desired customized information. For example, if the customer 99 is entitled to two car washes under a reward program, but the terms of the program only permit one car wash per week, an algorithm may determine that the fuel dispenser should offer the earlier expiring car wash to the customer 99. Likewise, algorithms may be used to define who, among multiple parties, is funding an offer, and thus which of different rules may apply to the offer. Customized information may be transmitted to the fuel dispensing system 30 regardless of whether the integration server 20 directly receives the customer identifier. In fact, in some embodiments, some or all of the customized information may be independent of the customer identifier. For example, the customized information may be a mere indication of approval or denial of the transaction in the example of FIG. 9. Alternatively, the customized information may relate to the particular location of the fuel dispenser or other factors outside of the identity of the customer 99. Thus, if a particular service station desires to offer discount coffee before 9 am on weekends, the integration server 20 may transmit customized information relating to the discount only during the appropriate dates, days, and/or times and only to those fuel dispensers associated with that service station. Likewise, the customization may allow for modification to the algorithm to change the types of transactions for which an offer is valid. The algorithm may be stored in and processed by the integration server 20. Alternatively, the integration server 20 may transmit data to and receive data from another server or servers configured to process algorithms or otherwise provide relevant data to the integration server 20 to transmit to the appropriate fuel dispensers. For example, the integration server 20 may transmit data to a loyalty server 24 for processing, and then the integration server 20 may receive data from the loyalty server 24 for further use.

The integration server 20 may allow the ability to define how an offer is delivered to the customer 99. For example, the offer may be presented to the customer 99 as an immediate discount offered at the fuel dispensing system 10 (e.g., at the customer interface 90), as a voucher on the receipt for the transaction, or in some other form. The customer 99 may have the option to “opt-in” for a particular offer or type of offer. Likewise, the customer 99 may have the option of the format of the offer (e.g., email, Short Message Service (SMS), mobile applications (Apps.), etc.).

The database 21 may include an indication of whether a particular offer is a single-use offer, a multiple use offer, or an unlimited use offer. Likewise, other parameters may allow for expiration of offers or conditions necessary for an offer to be valid. Offers may be in the form of public and/or private coupons printed on a receipt or otherwise distributed.

The systems, methods, and apparatus described herein may allow for the ability for the integration server 20 to interface with customers mobile phone to initiate a fuel purchase and receive electronic receipts to their phone, (e.g., Near Field Communication (NFC) payment options, etc.). Similarly, the integration server 20 may communicate with social media platforms (e.g., Foursquare, Facebook, etc.) in real-time to redeem third party offers. The teachings herein may allow for the combination and/or prioritizing of offers and messages based on business rules before presenting the offers and messages to the customer 99 via the customer interface 90 in the fuel pump 30 and/or other method of communication (e.g., the customer's mobile device or other communication near the particular fuel dispenser 30 of the fuel dispensing system 10). Likewise, the described systems, methods, and apparatus may allow the ability to interface with the fuel dispensing system 10 and get a response to generate line item discounts and to have additional messaging to appear on the customer interface 90 or via other method of communication to the customer 99 at initiation of the transaction.

Customers may be identified for offers based on personal information (e.g., birthday, “likes,” buying habits, etc.) provided by the customer, or gathered from third parties. Using the systems, methods, and apparatus described, various dynamic processes can occur. For example, when a customer qualifies for multiple offers from different channels, these may all be “added” and applied to a single transaction within an agreed framework/set of rules, including any of the following: adding together all offers, partly adding offers (e.g., add offers, but only provide messaging from one offer), and logic controlled treatment of offers (e.g., contradictory offers based on onsite/offsite conditions, mutually exclusive offers, and offers which are not to be added with other offer(s)). Changing the logic at the integration server 20 or associated servers (e.g., loyalty server 24 or non-loyalty server 25) in communication with the integration server 20 may readily change the rules for treatment of multiple offers. Thus, changes can readily be made to limit the number of offers a customer can receive in one transaction, to allow customers to select which offers to combine, and/or limit the offer options presented to the customer.

Creation and management of loyalty offers from multiple sources information (loyalty transactions, customer information and transaction history) may be done by the integration server 20 or servers associated with the integration server 20 prior to presenting a line item discount to be offered to the customer 99 at the fuel dispensing system 10 (e.g., at the customer interface 90). Customers may be required to meet one or more onsite purchase conditions to qualify for a specific offer. For example, purchase conditions may include purchase of fuel or diesel products, purchase of items in the service station, payment with a specific card or card type, payment with cash, payment with another particular method of payment, purchase of a specific car wash, or purchase a specific auto service. Similarly, customers may be required to meet one or more onsite non-purchase conditions to qualify for a specific offer. For example, the customer may be required to “check-in” on a mobile/web-based app, provide identification through location based services, or scan a QR code or NFC tag at the fuel dispenser 30. Additionally or alternatively, customers may be required to meet one or more offsite condition to qualify for a specific offer. Examples include shopping at a third party loyalty partner, participate in an active promotion for a targeted loyalty category, participate in an active promotion for historic purchase behavior, participate in an active promotion for attitudinal segment, participate in an active promotion for customer preferences, and engage in predefined social media interaction.

Offers managed by a wholesaler may be set up through a database or other portal accessible to the corresponding wholesaler and referenced by the integration server 20, including servers that process data and transmit information to integration server 20.

The messaging provided may be customized based on any view of the individual customer. Messaging may be sent to the fuel dispensing system 10, printed on the receipt, displayed on the price pole, and/or sent to the customer's mobile device or email account and/or otherwise communicated to the customer 99. Messages may be configured to support content from a centralized owner, wholesalers, or third parties within a pre-defined framework. Receipt messaging may support Hyper Text Markup Language (HTML) content to be printed at the site.

Other advantages of the systems, methods, and apparatus include the ability to transmit a survey or other questionnaire to the fuel dispensing system 10 (e.g., customer interface 90) or other collection device (e.g., the customer's mobile device or other onsite device having a user input) and collect responses from customers. Likewise, data from the customer's social media profile may be used to customize the messaging. Offsite messaging may be provided to the customer in one or more of the following ways: social media, text messaging, wireless applications (smartphone), and email. The messaging framework may support a tag-based system where known items like name or price can be represented by a placeholder and replaced during runtime.

The database 21 or databases can include a profile for each customer such that identification of the customer (e.g., via customer identifier) is associated with the profile which can include information such as payment card and other account information. Payment Information stored in a customer's profile may be used to authorize the transaction. The integration server 20 may request payment information from the database 21 and the database 21 may respond to the loyalty request with the customer's payment card details to be routed for authorization to the payment processing center 22, after which the integration server 20 may respond to the fuel dispensing system 10 with an authorization to release the fuel dispensing apparatus 50, causing fuel to flow through the nozzle 60. Likewise, the integration server 20 may request loyalty information from the database 21 and the database 21 may respond to the loyalty request with a discount to be applied at the fuel dispensing system 10. Similarly, the integration server 20 may request other information from the database 21 and the database 21 may respond with the requested information for use by the integration server 20.

Based on the customer's profile, steps in the transaction process may be remotely changed and/or disabled. For example, zip code prompting may be enabled/disabled, the pump authorization limit may be changed, the signature prompt may be enabled/disabled, the printing of receipts may be enabled/disabled, car wash prompts may be enabled/disabled, service station offers may be enabled/disabled, fuel grade preferences may be selected and automatically released without the need for the customer to select the grade at the fuel dispenser 30.

Any functionality may be turned on/off at any level, including at an individual site, at a wholesaler, at a location, in a state, on a date, at a time. Wholesalers may manage (create, edit, and/or delete) offers. Similarly, wholesalers may arrange sites into groups, and manage offers at the site or group level. Wholesalers may create targeted offers based on customer behavior (e.g., number of transactions, type of transactions, frequency, etc). Wholesalers may also determine the sites where offers can be earned and redeemed. The validity of offers may be controlled based on any of a number of variables, including date ranges as well as times of day. Wholesalers may view reports on activity and success of programs and rewards across sites and groups. Wholesalers may attach dynamic messages to the rewards, and/or to the site or group.

The system may access customer data such as linked loyalty accounts, linked social media accounts, and customer demographic data. Customers may create and manage their profile via a public portal. Additionally, customer data may be loaded from multiple external data sources. The customer may have the ability to set privacy settings around use of linked accounts.

The system may provide the ability to request multiple different loyalty offers from various third parties based on their respective interfaces. The system may provide the ability to request loyalty offers through the loyalty requests interface, and the ability to transmit notification of the loyalty transaction completions to third parties after successful execution of a transaction. The system may be able to push formatted transactions data to settlements systems and operate on either a scheduled batch or real-time operations via Secure File Transfer Protocol (SFTP), BizTalk or other industry standard protocol. The application may log all loyalty transactions to forward to the loyalty server 24, settlements and other external system in batch or real-time. The loyalty server 24 may process the transaction log and batch that information to settlements systems. The application may transmit formatted reporting data to a reporting system. The system may provide the ability to transmit notifications of transaction completions to corporate services upon successful execution of a transaction. The system may provide the ability to send email and/or mobile receipts or messages to the consumer, based on their profile preferences (e.g., the system may send the receipt upon completion of the transaction).

In some embodiments, the integration server 20 may respond to requests from the fuel dispensing system 10 within a few seconds. The response time may include the time required to interface with the database 21, the payment-processing center 22, and any other third parties. Encryption may be provided for transactions of customer identifier or other customer information. However, encryption may not be necessary for data transmitted over private leased lines. Encryption requirements for business data (such as fuel dispenser identifier) may be minimal Thus, the embodiments of FIG. 9 may require minimal encryption of the integration server 20 and the fuel dispensing system 10. Where appropriate, Payment Card Industry (PCI) compliance standards must be met as specified by PCI and would require PCI certification.

The integration server 20 may be capable of communication with third parties using the following interfaces: Extensible Markup Language (XML)/Simple Object Access Protocol (SOAP), BizTalk, File Transfer Protocol (FTP)/SFTP, FileMover, Transmission Control Protocol (TCP) Sockets, Petroleum Conveniance Alliance for Technology Standards (PCATS). The integration server 20 may be efficient in the use of processing and storage resources for (utilization during peak business, load balancing across servers, disk drives fit required growth patterns). The integration server 20 may be capable of running under various hosting models, including residing as a public cloud, a private cloud, a hosted server, or as a company datacenter. Two exemplary cloud providers include Amazon, and Azure.

The integration server 20 may use mechanisms to enhance performance (e.g., caching, Content Delivery Network (CDN)). The integration server 20 may be configured to integrate with certain existing payment terminals, such as those available from Gilbarco, VeriFone, TDL, and Radiant. The integration server 20 may have the ability to integrate with multiple third party web services that provide varying levels of services (e.g., using appropriate Application Programming Interfaces (API's)). The integration server 20 may communicate balance inquiries in real-time during the course of a transaction through a balance inquiries interface of the loyalty server 24 or any other server. Similarly, the integration server 20 may communicate loyalty requests in real-time during the course of a transaction through a loyalty requests interface (e.g., when the database 21 includes a loyalty database). The integration server 20 may communicate loyalty completions in real-time during the conclusion of a transaction through a loyalty completions interface. The integration server 20 may also communicate issuance of loyalty programs through an issuance interface. The integration server 20 may communicate with a site point of sale through a point of sale specific translation layer. A batch process may parse transaction records to establish a mapping between credit card numbers and loyalty accounts. A batch process may translate loyalty rewards stored in a particular database (analytics/targeting database) into the database 21, which may be associated as or considered a loyalty reward system.

Necessary interfaces may be made available separate from the fuel dispensing system 10. Likewise, logic may extend beyond loyalty and logical operations may be applied separate from loyalty logic operations. The integration server 20 may be flexible, allowing new value propositions to be introduced quickly (e.g., in 3 to 6 months, less than about 3 months, or even faster). The integration server 20 may have the ability to process and validate local loyalty tokens in real-time from various third parties based on their respective interfaces. The integration server 20 may have the ability to prioritize in real-time the various offers coming to the consumer based on their profile, and on business rules. The integration server 20 may include multiple drives, storages, etc. Further, the integration server 20 may merely direct communications to and from other elements of the system for dispensing fuel. Alternatively, the integration server 20 may perform one or more functions, including that of the controller 70, and the database 21, such that the integration server 20 transforms data in addition to routing various communications.

The integration server 20 may integrate with existing or new point of sale systems via SOAP and Representation State Transfer (RESTful) services using TCP socket communications. The sever 20 may support abstraction of a point of sale communications layer from the fuel dispenser 30 or even from the site 100. The sever 20 may support abstraction of a third party communication layer from the fuel dispenser 30 or even from the site 100. Finally, the integration server 20 may provide full support for customer messaging through a PCATS protocol.

Those of skill in the art will appreciate that many modifications and variations are possible in terms of the disclosed embodiments, configurations, materials, and methods without departing from their scope. For example, elements from one embodiment may supplement or replace elements from another embodiment. Accordingly, the scope of the claims and their functional equivalents should not be limited by the particular embodiments described and illustrated, as these are merely exemplary in nature and elements described separately may be optionally combined.

What is claimed is:

1. A fuel dispensing system comprising:
a fuel dispenser comprising a housing, and a fuel dispensing apparatus at least partially mounted in the housing;
a controller operatively coupled to the fuel dispensing apparatus;
an electronic payment server operatively coupled to the controller;
a nozzle operatively coupled to the fuel dispensing apparatus and the controller; and
an interface operatively coupled to the electronic payment server and configured to receive information from an integration server that is configured to communicate with a loyalty server;
wherein the controller is configured to selectively permit the dispensing of fuel through the nozzle in response to information received from the integration server.

2. The fuel dispensing system of claim 1, wherein the integration server is configured to communicate with a non-loyalty server.

3. The fuel dispensing system of claim 1, wherein the information from the integration server comprises an indication of payment authorization, pricing information, discount information, preselection of fuel type, or messaging information.

4. The fuel dispensing system of claim 1, comprising a customer interface mounted in the housing and operatively coupled to the controller.

5. The fuel dispensing system of claim 4, wherein, the customer interface is configured to display a message in response to the receipt of information from the integration server.

6. The fuel dispensing system of claim 1, comprising a customer interface configured to transmit information from the fuel dispenser to the integration server.

7. The fuel dispensing system of claim 6, wherein the information transmitted from the fuel dispenser comprises a customer identifier.

8. The fuel dispensing system of claim 6, wherein customer interface comprises a keypad, a barcode scanner, a magnetic stripe reader, a “tap and pay” antenna, other input at the fuel dispenser, or a customer's cellular network.

9. The fuel dispensing system of claim 6, wherein the information from the fuel dispenser is transmitted to the integration server indirectly.

10. The fuel dispensing system of claim 1, comprising a fuel dispenser identifier, accessible to a customer, the fuel dispenser identifier being configured such that the customer can send information about the fuel dispenser identifier through the customer's cellular network to the integration server.

11. The fuel dispensing system of claim 10, wherein the fuel dispenser identifier comprises a Quick Response (QR) Code, a Universal Product Code (UPC), or Global Positioning System (GPS) Coordinates.

12. The fuel dispensing system of claim 1, wherein the controller is remote from the fuel dispenser.

13. The fuel dispensing system of claim 12, wherein the controller is operatively coupled to a plurality of fuel dispensers.

14. A method comprising:
receiving, at an integration server that is configured to communicate with an electronic payment server and with a loyalty server, a message including a customer identifier and a fuel dispenser identifier;
transmitting, from the integration server to the loyalty server, a loyalty request message including the customer identifier;
receiving, at the integration server from the loyalty server, a loyalty completion message; and
transmitting, from the integration server, an instruction to dispense fuel at a fuel dispenser corresponding to the fuel dispenser identifier.

15. The method of claim 14, comprising transmitting, based on the loyalty completion message, a loyalty message from the integration server to the electronic payment server.

16. The method of claim 14, wherein the integration server is configured to receive the message from a fuel dispenser, via the electronic payment server, in response to a customer providing an indication of the customer identifier at the fuel dispenser.

17. The method of claim 14, wherein the integration server is configured to receive the message from a customer's cellular network in response to a customer interacting with a fuel dispensing system operatively coupled to the electronic payment server.

18. The method of claim 14, wherein the message from the integration server to the electronic payment server causes the display of a message tailored to a customer associated with the customer identifier.

19. The method of claim 14, comprising:
transmitting, from the integration server to a non-loyalty server, a non-loyalty request message;
receiving, at the integration server from the non-loyalty server, a non-loyalty completion message; and
transmitting, based on the non-loyalty completion message, a non-loyalty message from the integration server to the electronic payment server.

20. A system for dispensing fuel comprising:
a housing;
a fuel dispensing apparatus at least partially mounted in the housing;
a controller operatively coupled to the fuel dispensing apparatus;
an electronic payment server operatively coupled to the controller;
a nozzle operatively coupled to the fuel dispensing apparatus and the controller;
an interface operatively coupled to the electronic payment server;
an integration server operatively coupled to the electronic payment server; and
a loyalty server operatively coupled to the integration server.

21. The system of claim 21, wherein the controller is configured to selectively permit the dispensing of fuel through the nozzle in response to information received from the integration server.
